(19) United States
(12) Patent Application Publication
(10) Pub. No.: US 2021/0187959 A1
(43) Pub. Date: Jun. 24, 2021

(54) INK TANK, INK JET RECORDING DEVICE, AND INK JET RECORDING METHOD

(71) Applicant: FUJIFILM Corporation, Tokyo (JP)

(72) Inventor: Masao IKOSHI, Kanagawa (JP)

(73) Assignee: FUJIFILM Corporation, Tokyo (JP)

(21) Appl. No.: 17/190,412

(22) Filed: Mar. 3, 2021

Related U.S. Application Data
(63) Continuation of application No. PCT/JP2019/031327, filed on Aug. 8, 2019.

(30) Foreign Application Priority Data
Sep. 27, 2018 (JP) 2018-181290

(51) Int. Cl. B41J 2/175; B41J 2/14

(52) U.S. Cl. CPC B41J 2/17513; B41J 2202/03; B41J 2/14

(57) ABSTRACT

An ink tank including: a container for storing an ink jet ink; and a silicon-containing member housed in the container, in which an SN ratio that is a ratio of a total surface area S m² of the silicon-containing member to a capacity V m³ of the container is 40 or greater. An ink jet recording device includes the ink tank and an ink jet head including a nozzle member containing silicon. An ink jet recording method includes preparing the ink tank, supplying the ink jet ink to an ink jet head including a nozzle member containing silicon, and jetting an ink jet ink from the nozzle member of the ink jet head.

### CROSS-REFERENCE TO RELATED APPLICATIONS

This application is a Continuation of PCT International Application No. PCT/JP2019/031327 filed on Aug. 8, 2019, which claims priority under 35 U.S.C § 119(a) to Japanese Patent Application No. 2018-181290 filed on Sep. 27, 2018. Each of the above application(s) is hereby expressly incorporated by reference, in its entirety, into the present application.

### BACKGROUND OF THE INVENTION

### 1. Field of the Invention

The present disclosure relates to an ink tank, an ink jet recording device, and an ink jet recording method.

### 2. Description of the Related Art

Various studies have been conducted on ink jet recording.

For example, JP2011-063000A discloses an image forming method capable of suppressing the deterioration of a head member (in particular, a head plate and an ink flow path) and stably forming a highly precise image over a long period of time in the image formation using an ink jet head having an ink circulation system, including a step of jetting, from an ink jet head including: a plurality of droplet jetting elements; and an ink circulation device which has a common flow path communicating with each of the plurality of droplet jetting elements via a supply path and a common circulation path communicating with each of the plurality of droplet jetting elements via a reflux path, supplies an ink composition from the common flow path to the plurality of droplet jetting elements, and circulates the ink composition through the common circulation path, an ink composition containing at least one selected from silicic acid compounds.

JP1998-259332A (JP-H10-259332A) discloses an ink of an ink jet recording head having excellent water repellency on a nozzle surface of the ink jet recording head and stably ensuring high printing quality for a long period of time, in which glass is dissolved in an ink which contains a dissolved or dispersed colorant material and is used in the ink jet recording head in which the nozzle surface made of silicon or silicon oxide is coated with a fluoroalkylsilane water-repellent and oil-repellent film. In JP1998-259332A (JP-H10-259332A), specifically, the ink is produced in a glass container while the glass container is heated, so that the glass is dissolved in the ink.

### SUMMARY OF THE INVENTION

However, in the technology described in JP2011-063000A, the composition of the ink is limited since the ink is required to contain a silicic acid compound. Accordingly, it is thought that it is desirable to suppress the deterioration of a nozzle member containing silicon in the ink jet head by a configuration of an ink tank for storing the ink without depending on the composition of the ink.

In the technology described in JP1998-259332A (JP-H10-259332A), as a device for producing an ink, a special device including a glass container and a heater for heating the glass container is required. Accordingly, it is thought that it is desirable to suppress the deterioration of a nozzle member containing silicon in the ink jet head by a configuration of an ink tank for storing the ink without depending on the device for producing the ink.

The present disclosure is contrived in view of the above circumstances.

An object to be achieved by an aspect of the present disclosure is to provide an ink tank, an ink jet recording device, and an ink jet recording method capable of suppressing the deterioration of a nozzle member containing silicon in an ink jet head.

Specifically, the following aspects are included in order to achieve the object.

<1> An ink tank comprising: a container for storing an ink jet ink; and

a silicon-containing member housed in the container,

in which an S/V ratio that is a ratio of a total surface area S m² of the silicon-containing member to a capacity V m³ of the container is 40 or greater.

<2> The ink tank according to <1>, in which a silicon content of the silicon-containing member is 20 mass % or greater with respect to a total amount of the silicon-containing member.

<3> The ink tank according to <1> or <2>, in which the S/V ratio is 50 or greater.

<4> The ink tank according to any one of <1> to <3>, in which the silicon-containing member includes a plurality of silicon-containing solid pieces.

<5> The ink tank according to <4>, in which each of the plurality of silicon-containing solid pieces has a size of 50 μm or greater.

<6> The ink tank according to <4> or <5>, in which as the plurality of silicon-containing solid pieces, at least one selected from the group consisting of silicon-containing substrates and silicon-containing beads is used.

<7> The ink tank according to any one of <1> to <6>, further comprising: a stirring unit for stirring the ink jet ink stored in the container.

<8> The ink tank according to any one of <1> to <7>, in which the ink jet ink contains a reactive dye.

<9> An ink jet recording device comprising: the ink tank according to any one of <1> to <8>; and

an ink jet head including a nozzle member containing silicon.

<10> An ink jet recording method comprising: preparing the ink tank according to any one of <1> to <8>, in which an ink jet ink is stored in the container;

supplying the ink jet ink stored in the container to an ink jet head including a nozzle member containing silicon; and

jetting the ink jet ink supplied to the ink jet head from the nozzle member of the ink jet head.

<11> The ink jet recording method according to <10>, in which the ink jet ink contains a reactive dye.

According to the aspect of the present disclosure, an ink tank, an ink jet recording device, and an ink jet recording method capable of suppressing the deterioration of a nozzle member containing silicon in an ink jet head are provided.

### BRIEF DESCRIPTION OF THE DRAWINGS

FIG. 1 is a conceptual diagram schematically showing an example of an ink tank according to an embodiment of the present disclosure.

FIG. 2 is a conceptual diagram schematically showing an example of an ink jet recording device according to an embodiment of the present disclosure.

FIG. 3 is a schematic cross-sectional view schematically showing a cross-section of a nozzle plate in FIG. 2.

### DESCRIPTION OF THE PREFERRED EMBODIMENTS

In the present disclosure, a numerical range expressed using “to” represents a range including numerical values before and after “to” as a lower limit and an upper limit.

In the present disclosure, regarding the amount of each component in a composition, in a case where there are a plurality of substances corresponding to the component in the composition, the amount means a total amount of the plurality of substances present in the composition, unless otherwise specified.

In numerical ranges described stepwise in the present disclosure, an upper limit or a lower limit described in a numerical range may be substituted with an upper limit or a lower limit of another numerical range described stepwise, or may be substituted with a value shown in examples.

In the present disclosure, the term “step” includes not only an independent step but also cases where it cannot be clearly distinguished from other steps, so long as the desired effect of the step can be achieved.

In the present disclosure, the term “silicon-containing” means that silicon (that is, Si) is contained. The term “silicon-containing” includes not only cases where a single substance of silicon is contained but also cases where a silicon compound is contained.

[Ink Tank]

An ink tank according to the embodiment of the present disclosure includes a container for storing an ink jet ink (hereinafter, also simply referred to as “ink”) and a silicon-containing member housed in the container, and an SN ratio that is a ratio of a total surface area S m² of the silicon-containing member to a capacity V m³ of the container is 40 or greater.

With the ink tank according to the embodiment of the present disclosure, it is possible to suppress the deterioration of a nozzle member containing silicon (hereinafter, also referred to as “silicon-containing nozzle member”) in an ink jet head.

The reason why such an effect is obtained is not clear, but is presumed as follows.

The ink jet head usually includes a nozzle member containing silicon (that is, Si), that is, a silicon-containing nozzle member. The silicon-containing nozzle member is provided with a jetting hole (that is, nozzle). The ink jet recording is performed by jetting an ink from the nozzle. While the ink jet recording is repeatedly performed using the ink jet head, the silicon-containing nozzle member may deteriorate due to the elution of the silicon into the ink from the silicon-containing nozzle member.

Regarding this, the ink tank according to the embodiment of the present disclosure includes a container for storing an ink and a silicon-containing member housed in the container. In a case where the ink is stored in the container, the silicon is thought to be gradually eluted from the silicon-containing member to the ink while the ink is stored in the container. It is thought that by supplying the ink containing the eluted silicon to the ink jet head, the elution of the silicon from the silicon-containing nozzle member in the ink jet head is suppressed, whereby the deterioration of the silicon-containing nozzle member is suppressed.

It is thought that in the ink tank according to the embodiment of the present disclosure, an SN ratio that is a ratio of a total surface area S m² of the silicon-containing member to a capacity V m³ of the container is 40 or greater, and thus the elution of the silicon from the silicon-containing nozzle member described above is effectively suppressed, and moreover, the deterioration of the silicon-containing nozzle member is effectively suppressed.

An ink-repellent film containing an alkylsilane fluoride compound may be provided on at least a part of a nozzle surface (that is, a surface on the ink jetting side) of the silicon-containing nozzle member. A function of the ink-repellent film is to increase the ink repellency of the nozzle surface (that is, to suppress wet spreading of the ink in the nozzle surface), thereby suppressing the inclined ink jetting or poor ink jetting. Even in a case where the silicon-containing nozzle member is provided with the ink-repellent film, the silicon may be eluted from the silicon-containing nozzle member to the ink. In a case where the silicon is eluted from the silicon-containing nozzle member, the ink-repellent film at a part where the silicon is eluted may deteriorate or be peeled off, and the ink repellency of the nozzle surface may be impaired.

The ink tank according to the embodiment of the present disclosure is effective also in a case where the silicon-containing nozzle member is provided with an ink-repellent film. In this case, due to the effect of suppressing the deterioration of the silicon-containing nozzle member by the ink tank according to the embodiment of the present disclosure, the deterioration or peeling of the ink-repellent film can be suppressed, and moreover, the service life of the ink-repellent film can be extended.

It is thought that in the technology described in JP2011-063000A, the deterioration of the silicon-containing nozzle member is suppressed by a silicic acid compound (for example, colloidal silica) contained in the ink.

However, in the technology described in JP2011-063000A, the composition of the ink is limited since the ink is required to contain a silicic acid compound (for example, colloidal silica).

Furthermore, in a case where the ink containing the silicic acid compound further contains a reactive dye, the silicic acid compound precipitates by the interaction between the silicic acid compound and the reactive dye, and as a result, there is a concern that problems may occur such as a reduction in the temporal stability of the ink and clogging of the filter in the ink jet recording device.

Compared to the technology described in JP2011-063000A, the ink tank according to the embodiment of the present disclosure is advantageous in that it is possible to suppress the deterioration of the silicon-containing nozzle member without depending on the composition of the ink.

It is thought that in the technology described in JP1998-259332A (JP-H10-259332A), while a glass container is heated, an ink is produced in the glass container to dissolve the glass in the ink, and thus the deterioration of the silicon-containing nozzle member is suppressed.

However, in the technology described in JP1998-259332A (JP-H10-259332A), as a device for producing an ink, a special device including a glass container and a heater for heating the glass container is required.

In addition, in the technology described in JP1998-259332A (JP-H10-259332A), since the glass container is used as a silicon supply source, the surface area from which the silicon is eluted may be insufficient, and a sufficient effect may not be obtained in the suppression of the deterioration of the silicon-containing nozzle member.

Furthermore, in a case where the ink contains a dye, the dye may be decomposed or altered by heating of the glass container.

Compared to the technology described in JP1998-259332A (JP-H10-259332A), the ink tank according to the embodiment of the present disclosure is advantageous in that it is possible to suppress the deterioration of the silicon-containing nozzle member without depending on the device for producing an ink.

Hereinafter, elements of the ink tank according to the embodiment of the present disclosure will be described.

<Container>

The ink tank according to the embodiment of the present disclosure includes a container for storing an ink.

The container is not particularly limited as long as it can store an ink.

Regarding the container, a configuration of a main tank of a usual ink jet recording device can be appropriately referred to.

The container may have a structure of a usual ink tank, such as an ink supply port for supplying an ink to the container and a discharge port for discharging an ink from the container.

A capacity V of the container is not particularly limited. The capacity V is preferably 0.0001 m³ to 0.1 m³, more preferably 0.0005 m³ to 0.05 m³, and even more preferably 0.001 m³ to 0.02 m³.

The material of the container is not particularly limited, and examples of the material include plastics such as polyethylene, polypropylene, and acryl.

<Silicon-Containing Member>

The ink tank according to the embodiment of the present disclosure includes a silicon-containing member housed in the container.

As the silicon-containing member housed in the container, only one type or two or more types may be used.

The ink tank according to the embodiment of the present disclosure has an S/V ratio of 40 or greater.

In the present disclosure, the S/V ratio is a ratio of a total surface area S m² of the silicon-containing member to a capacity V m³ of the container (that is, a ratio of S to V where V represents a capacity of the container expressed in the unit of m³ and S represents a total surface area of the silicon-containing member expressed in the unit of m²).

Accordingly, the elution of the silicon from the silicon-containing nozzle member described above is effectively suppressed, and moreover, the deterioration of the silicon-containing nozzle member is effectively suppressed.

From the viewpoint of more effectively exhibiting the effects, the S/V ratio is preferably 45 or greater, more preferably 50 or greater, even more preferably 55 or greater, and still more preferably 60 or greater.

From the viewpoint of the effect of suppressing the deterioration of the silicon-containing nozzle member, the upper limit of the S/V ratio is not particularly limited.

From the viewpoint of storage of a larger amount of an ink in the ink tank, the S/V ratio is preferably 5,000 or less, and more preferably 1,000 or less.

As described above, the silicon-containing member functions as a supply source for supplying silicon to the ink. With such a function, the effect of suppressing the deterioration of the silicon-containing nozzle member is exhibited.

From the viewpoint of more effectively exhibiting the function, the silicon content in the silicon-containing member is preferably 20 mass % or greater, more preferably 25 mass % or greater, and even more preferably 30 mass % or greater with respect to a total amount of the silicon-containing member.

The silicon content in the silicon-containing member may be 100 mass %, or less than 100 mass %.

In the present disclosure, the silicon content in the silicon-containing member is determined by an X-ray reflectivity method (XRR).

The silicon-containing member may be a single silicon-containing solid, may include a plurality of silicon-containing solid pieces, or may be formed of a plurality of silicon-containing solid pieces.

From the viewpoint of easily increasing the total surface area S of the silicon-containing member, the silicon-containing member is preferably formed of a plurality of silicon-containing solid pieces.

Examples of the single silicon-containing solid include silicon-containing substrates such as silicon substrates (for example, monocrystalline silicon substrates and polycrystalline silicon substrates), silicon alloy substrates, silicon compound (for example, SiC and SiN) substrates, and glass substrates; and silicon-containing ingots such as silicon ingots, silicon alloy ingots, silicon compound ingots, and glass ingots.

Examples of the glass in the glass ingot include borosilicate glass, quartz glass, and soda-lime glass.

Examples of each of the plurality of silicon-containing solid pieces may be the same as the specific examples of the single silicon-containing solid.

As the plurality of silicon-containing solid pieces, at least one selected from the group consisting of silicon-containing substrates and silicon-containing beads is preferable from the viewpoint of further increasing the total surface area S of the silicon-containing member.

The silicon-containing beads mean a plurality of silicon-containing particles.

Examples of the silicon-containing beads include silicon beads formed of a plurality of silicon particles, silicon alloy beads formed of a plurality of silicon alloy particles, silicon compound beads formed of a plurality of silicon compound particles, and glass beads formed of a plurality of glass particles.

Examples of the glass in the glass particles include borosilicate glass, quartz glass, and soda-lime glass.

The shape of each silicon-containing particle in the silicon-containing beads is not particularly limited.

Examples of the shape of the silicon-containing particles include an ellipsoidal shape (including a spherical shape), a rod shape, a plate shape, a polyhedron shape (including a cubic shape), and an indefinite shape.

The silicon-containing particles may have a porous structure.

The size of each of the plurality of silicon-containing solid pieces is preferably 50 μm or greater, more preferably 0.1 mm or greater, and even more preferably 0.5 mm or greater from the viewpoint of further suppressing the leakage of the silicon-containing solid pieces from the ink tank (container) and the clogging of the filter due to the leakage.

Here, the size of the silicon-containing solid piece means the maximum length of each silicon-containing solid piece.

For example, the maximum length of silicon-containing particles having a spherical shape corresponds to a diameter of the silicon-containing particles, and the maximum length of silicon-containing particles having an elliptical shape other than the spherical shape corresponds to a major axis diameter of the silicon-containing particles.

The upper limit of the size of each of the plurality of silicon-containing solid pieces is not particularly limited.

In a case where the plurality of silicon-containing solid pieces are silicon-containing beads, the upper limit of the size of the silicon-containing particles is preferably 10 mm or less, and more preferably 5 mm or less from the viewpoint of easily increasing the total surface area S.

The method of measuring the total surface area S of the silicon-containing member is selected according to the specific form of the silicon-containing solid piece.

In a case where the silicon-containing member is a silicon-containing substrate or a silicon-containing ingot, the area of the entire surface of the silicon-containing substrate is measured according to a usual method, and the obtained value is defined as the total surface area S.

In a case where silicon-containing beads are used as the silicon-containing member, a specific surface area (m²/g) of the silicon-containing member is measured by a krypton adsorption method, and the obtained specific surface area (m²/g) is multiplied by a mass (g) of the silicon-containing member to determine the total surface area S.

<Stirring Unit>

The ink tank according to the embodiment of the present disclosure preferably includes a stirring unit for stirring the ink jet ink stored in the container.

By stirring the ink jet ink in the container by the stirring unit, the elution of the silicon from the silicon-containing member can be further promoted. As a result, the effect of suppressing the deterioration of the silicon-containing nozzle member is more effectively obtained.

As the stirring unit, a known stirrer can be used without particular limitation.

Examples of the method of rotating the stirrer include a mechanical stirrer method of rotating a stirrer through a stirring shaft, and a magnetic stirrer method of magnetically rotating a stirrer.

<Silicon-Containing Member Housing Member>

The ink tank according to the embodiment of the present disclosure may include a silicon-containing member housing member that houses the silicon-containing member and allows an ink to pass through, but does not allow the silicon-containing member to pass through.

Accordingly, it is possible to further suppress the leakage of the silicon-containing solid pieces from the ink tank (container) and the clogging of the filter due to the leakage.

The silicon-containing member housing member preferably has a bag shape.

At least a part of the silicon-containing member housing member is preferably formed of at least one of filter paper, filter cloth, or net.

The ink tank according to the embodiment of the present disclosure may include an element other than those described above.

Regarding other elements, a configuration of a main tank of a usual ink jet recording device can be appropriately referred to.

A preferable aspect of the ink stored in the container of the ink tank according to the embodiment of the present disclosure will be described in the section “Ink Jet Recording Method”.

<Example of Ink Tank>

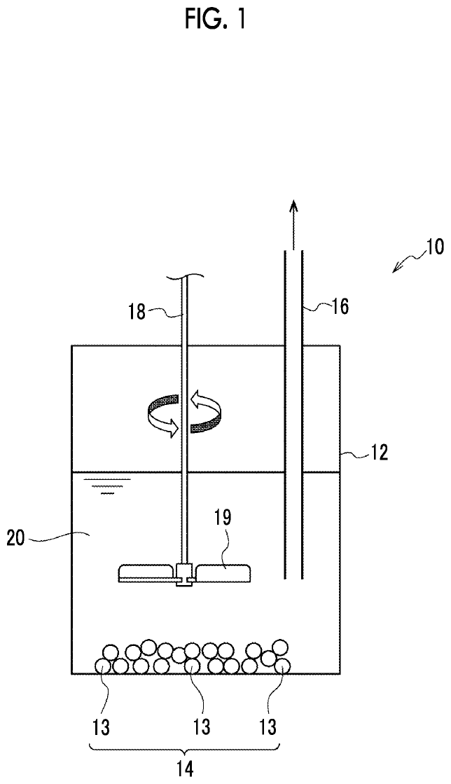

Hereinafter, an example of the ink tank according to the embodiment of the present disclosure will be described with reference to FIG. 1. The ink tank according to the embodiment of the present disclosure is not limited to this example.

FIG. 1 is a conceptual diagram schematically showing an ink tank 10 that is an example of the ink tank according to the embodiment of the present disclosure.

As shown in FIG. 1, the ink tank 10 includes a container 12 for storing an ink 20 and glass beads 14 (silicon-containing member) housed in the container 12. The glass beads 14 are formed of a plurality of glass particles 13.

The amount of the glass beads 14 is adjusted so that an SN ratio that is a ratio of a total surface area S (unit: m²) of the glass beads 14 to a capacity V (unit: m³) of the container 12 is 40 or greater.

The ink tank 10 further includes a stirrer 19 in the container 12 as a stirring unit for stirring the ink 20. The stirrer 19 is attached to one end of a stirring shaft 18.

The one end of the stirring shaft 18 is disposed in the ink 20, and the other end of the stirring shaft 18 is disposed outside the container 12.

The stirring shaft 18 is attached so as to be axially rotatable, and the other end is connected to a rotation motor (not shown). By operating the rotation motor, the stirring shaft 18 is axially rotated, and the stirrer 19 is rotated in conjunction with the shaft rotation. The ink 20 is stirred by the rotating stirrer 19.

The ink tank 10 further includes a discharge tube 16 for discharging the ink 20 from the container 12.

The ink 20 discharged from the discharge tube 16 finally reaches the ink jet head, and is jetted from the silicon-containing nozzle member of the ink jet head.

As described above, the ink tank 10 includes the glass beads 14 (silicon-containing member), and has an S/V ratio of 40 or greater. Accordingly, during the storage of the ink 20 in the container 12, silicon is eluted from the glass beads 14 to the ink 20, thereby suppressing the deterioration of the silicon-containing nozzle member in the ink jet head. A preferable range of the S/V ratio is as described above.

In a case where the ink 20 is stirred by the stirrer 19, the elution of the silicon from the glass beads 14 to the ink 20 is further promoted.

[Ink Jet Recording Device]

An ink jet recording device according to the embodiment of the present disclosure includes the above-described ink tank according to the embodiment of the present disclosure and the ink jet head including the silicon-containing nozzle member.

In the ink jet recording device according to the embodiment of the present disclosure, the ink stored in the container of the above-described ink tank according to the embodiment of the present disclosure is fed to the ink jet head, and the fed ink is jetted from the silicon-containing nozzle member of the ink jet head. The ink fed to the ink jet head contains silicon eluted from the silicon-containing member in the ink tank. Accordingly, the elution of the silicon from the silicon-containing nozzle member to the ink is suppressed, and thus the deterioration of the silicon-containing nozzle member is suppressed.

Regarding the configuration of the ink jet recording device according to the embodiment of the present disclosure, a configuration of a known ink jet recording device can be appropriately referred to.

As a known ink jet recording device, for example, known literature such as JP2011-063000A and WO2017/159551A can be appropriately referred to.

Examples of the silicon-containing nozzle member (that is, nozzle member containing silicon) include a silicon-containing nozzle plate that is a member having a plate shape.

As the silicon-containing nozzle plate, for example, a nozzle plate in which on a silicon substrate, a film of a metal oxide (silicon oxide, titanium oxide, chromium oxide, tantalum oxide (preferably Ta₂O₅), or the like) a metal nitride (titanium nitride, silicon nitride, or the like), a metal (zirconium, chromium, titanium, or the like), or the like is provided can be used.

Here, a silicon oxide film may be a film formed by oxidizing a part or the whole of a surface of a silicon substrate, or a film formed by a film forming method such as a chemical vapor deposition method (CVD) or a sputtering method.

In the silicon-containing nozzle plate, a part of the silicon may be substituted with glass (example: borosilicate glass, photosensitive glass, quartz glass, soda-lime glass).

An ink-repellent film containing an alkylsilane fluoride compound may be provided on at least a part of a nozzle surface of the silicon-containing nozzle member.

The function of the ink-repellent film is as described above.

Examples of the alkylsilane fluoride compound include fluoroalkyltrichlorosilanes such as C₈F₁₇C₂H₄SiCl₃ (referred to as “1H,1H,2H,2H-perfluorodecyltrichlorosilane” or “FDTS”) and CF₃(CF₂)₈C₂H₄SiCl₃; and fluoroalkylalkoxysilanes such as CF₃(CF₂)₈C₂H₄Si(OCH₃)₃, 3,3,3-trifluoropropyltrimethoxysilane, tridecafluoro-1,1,2,2-tetrahydrooctyltrimethoxysilane, and heptadecafluoro-1,1,2,2-tetrahydrodecyltrimethoxysilane.

<Example of Ink Jet Recording Device>

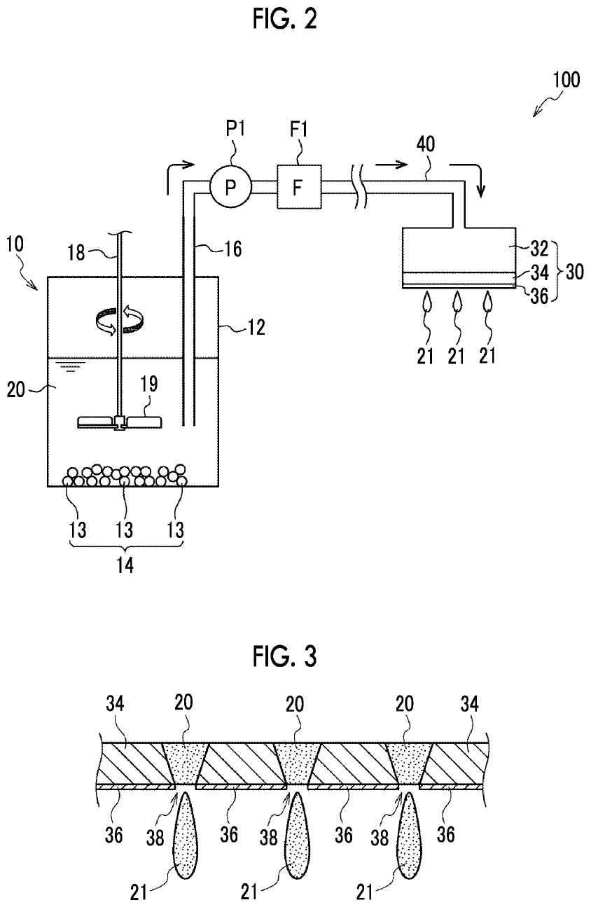

Hereinafter, an example of the ink jet recording device according to the embodiment of the present disclosure will be described with reference to FIG. 2. The ink jet recording device according to the embodiment of the present disclosure is not limited to this example.

FIG. 2 is a conceptual diagram schematically showing an ink jet recording device 100 that is an example of the ink jet recording device according to the embodiment of the present disclosure.

As shown in FIG. 2, the ink jet recording device 100 includes the ink tank 10 and an ink jet head 30.

The ink tank 10 is as described above.

The ink jet head 30 includes a head body 32 and a nozzle plate 34.

An ink-repellent film 36 is provided on a nozzle surface of the nozzle plate 34.

In the ink jet recording device 100, the ink 20 stored in the container 12 of the ink tank 10 is supplied to the ink jet head 30 through the discharge tube 16, a liquid feed pump P1, a filter F1, and a supply tube 40 (see the arrows in FIG. 2), and jetted as ink droplets 21 from the ink jet head 30.

Although not shown in FIG. 2, a constituent member of a known ink jet recording device (for example, see JP2011-063000A and WO2017/159551A) may be provided between the filter F1 and the supply tube 40.

Although a structure of the head body 32 is not shown in the drawing, regarding the structure of the head body 32, a structure of a known ink jet head (for example, see JP2011-063000A and WO2017/159551A) can be referred to.

The ink jet head 30 may be a shuttle scan type head or a line type (single pass type) head.

The ink jet recording device 100 may be provided with an ink circulation system as described in, for example, JP2011-063000A.

FIG. 3 is a schematic cross-sectional view schematically showing a cross-section of the nozzle plate 34 in FIG. 2.

As shown in FIG. 3, the nozzle plate 34 is provided with a plurality of nozzles 38 as through holes. The ink 20 supplied to the ink jet head 30 is jetted as ink droplets 21 through the nozzles 38.

The ink-repellent film 36 is provided on the nozzle surface (that is, the surface on the ink jetting side) of the nozzle plate 34.

Although not shown in the drawing, the nozzle plate 34 is formed of a silicon substrate and a SiO₂ film provided on a surface of the silicon substrate on the nozzle surface side. The ink-repellent film 36 is provided on the SiO₂ film of the nozzle plate 34.

The ink-repellent film 36 is a self-assembled monolayer (SAM) film of C₈F₁₇C₂H₄SiCl₃, and has an ink-repelling property.

The ink-repellent film 36 suppresses the inclined ink jetting, poor ink jetting, or the like.

The ink jet recording device 100 shown in FIG. 2 includes the above-described ink tank 10. Accordingly, the elution of the silicon from the nozzle plate 34 to the ink 20 is suppressed by the elution of the silicon from the glass beads 14 to the ink 20. Accordingly, the deterioration of the nozzle plate 34 is suppressed.

Due to the suppression of the deterioration of the nozzle plate 34, the deterioration or peeling of the ink-repellent film 36 is also suppressed. Accordingly, the extension of the service life of the ink-repellent film 36 is realized.

[Ink Jet Recording Method]

An ink jet recording method according to the embodiment of the present disclosure includes: preparing the ink tank according to the embodiment of the present disclosure in which an ink is stored in the container (hereinafter, also referred to as “preparation step”);

supplying the ink jet ink stored in the container to the ink jet head including the nozzle member containing silicon (hereinafter, also referred to as “supply step”); and

jetting the ink jet ink supplied to the ink jet head from the nozzle member of the ink jet head (hereinafter, also referred to as “jetting step”).

The ink jet recording method according to the embodiment of the present disclosure may optionally include other steps.

In the ink jet recording method according to the embodiment of the present disclosure, since the above-described ink tank according to the embodiment of the present disclosure is used, the deterioration of the silicon-containing nozzle member in the ink jet head is suppressed.

<Step of Preparing Ink Tank>

The preparation step is a step of preparing an ink tank in which an ink is stored in a container of the ink tank.

The preparation step may be a step in which an ink tank in which an ink is stored in a container in advance is simply prepared for use in the ink jet recording method according to the embodiment of the present disclosure, or may be a step in which an ink is injected into and then stored in a container of an ink tank.

In any case, the ink tank and the ink jet head may be connected, or may not be connected in the preparation step.

In a case where the ink tank and the ink jet head are not connected in the preparation step, the ink tank and the ink jet head are connected before the supply step to be described later.

The ink storing time in the container is preferably 24 hours or longer, more preferably 48 hours or longer, and even more preferably 72 hours or longer from the viewpoint of advancing the elution of the silicon from the silicon-containing member to the ink.

The upper limit of the ink storing time in the container is not particularly limited. From the viewpoint of more favorably maintaining ink quality, the upper limit of the ink storing time in the container of the ink tank is, for example, 1 month, 1.5 months, or the like.

The temperature of the ink in a case where the ink is stored in the container of the ink tank is not particularly limited, but from the viewpoint of more favorably maintaining ink quality, for example, 5° C. to 35° C., preferably 15° C. to 32° C., and more preferably 20° C. to 32° C.

(Ink)

The ink stored in the container of the ink tank is not particularly limited, and a known ink jet ink can be used.

Due to the following reasons, a reactive dye-containing ink is suitable as the ink stored in the container of the ink tank.

For example, as described in JP2011-063000A, the technology for suppressing the deterioration of a silicon-containing nozzle member in an ink jet head by a silicic acid compound (for example, colloidal silica) contained in an ink has been known.

However, by the studies of the inventors, it has been found that in a case where a silicic acid compound is further contained in the reactive dye-containing ink, the silicic acid compound may be dispersed and destabilized, and thus may precipitate. The precipitation of the silicic acid compound may cause the clogging of the filter, a reduction in the temporal stability of the ink, and the like.

Accordingly, the reactive dye-containing ink cannot substantially contain the silicic acid compound. Therefore, it is not possible to adopt the method of suppressing the deterioration of a silicon-containing nozzle member by a silicic acid compound contained in an ink.

Regarding this, in the ink jet recording method according to the embodiment of the present disclosure, the ink jet recording device according to the embodiment of the present disclosure is used, and thus even in a case where a reactive dye-containing ink is used, it is possible to suppress the deterioration of the silicon-containing nozzle member without allowing the ink to substantially contain a silicic acid compound.

Accordingly, in the ink jet recording method according to the embodiment of the present disclosure, in a case where a reactive dye-containing ink is used as the ink stored in the container of the ink tank, the deterioration of the silicon-containing nozzle member can be suppressed, and the clogging of the filter and a reduction in the temporal stability of the ink can also be suppressed.

Due to the above-described reasons, it is preferable that the reactive dye-containing ink substantially does not contain the silicic acid compound.

Here, the expression “substantially does not contain the silicic acid compound” means that the silicic acid compound content with respect to a total amount of the ink is less than 0.1 ppm by mass (including a case where the silicic acid compound content is 0 ppm by mass) (and the same hereinafter).

Here, 0.1 ppm by mass corresponds to 1×10⁻⁵ mass %.

The reactive dye-containing ink preferably contains water.

Examples of the ink containing water and a reactive dye include ink jet printing inks.

Examples of the reactive dye include C.I. Reactive Black 39, C.I. Reactive Brown 11, C.I. Reactive Yellow 95, C.I. Reactive Orange 12, and C.I. Reactive Orange 13.

As the reactive dye that can be contained in the ink, only one type or two or more types may be used.

—Example of Reactive Dye-Containing Ink—

Examples of the reactive dye-containing ink include the ink described in WO2017/159551A.

An examples thereof is an ink containing:

water;

C.I. Reactive Black 39 of which the content is 9 mass % to 11.5 mass % with respect to the total amount of the ink;

C.I. Reactive Brown 11 and/or C.I. Reactive Yellow 95 of which the total content is 5 mass % to 7.5 mass % with respect to the total amount of the ink;

C.I. Reactive Orange 12 and/or C.I. Reactive Orange 13 of which the total content is 2.5 mass % to 4 mass % with respect to the total amount of the ink;

a buffer of which the content is 0.1 mass % to 10 mass % (preferably 0.2 mass % to 5 mass %) with respect to the total amount of the ink;

ethylene glycol of which the content is 15 mass % to 30 mass % with respect to the total amount of the ink;

a water-miscible solvent of which the content is 0 mass % to 15 mass % (preferably 2.5 mass % to 7.5 mass %) with respect to the total amount of the ink;

a nonionic surfactant of which the content is 0.01 mass % to 2.5 mass % (preferably 0.01 mass % to 1 mass %) with respect to the total amount of the ink;

urea of which the content is 4 mass % to 14 mass % with respect to the total amount of the ink; and

a biocide of which the content is 0 mass % to 5 mass % with respect to the total amount of the ink.

It is preferable that the ink according to the one example substantially does not contain the silicic acid compound.

In the ink according to the one example, a total content of ethylene glycol and urea is preferably greater than 20 mass % with respect to the total amount of the ink.

In the ink according to the one example, a total content of C.I. Reactive Black 39, C.I. Reactive Brown 11, C.I. Reactive Yellow 95, C.I. Reactive Orange 12, and C.I. Reactive Orange 13 is preferably greater than 18 mass % with respect to the total amount of the ink.

In the ink according to the one example, the following compound (1) is preferable as the buffer.

R¹R²N—Ar—(Z)ₙ Compound (1)

In the compound (1), R¹ is a hydrogen atom or an alkyl group, R² is an alkyl group, Ar is a phenylene group, Z is SO₃X or CO₂X, X is a hydrogen atom or a cation, and n is 1 or 2.

In the ink according to the one example, the buffer is preferably an N,N-diethylsulfanilic acid.

In the ink according to the one example, the water-miscible solvent is preferably 2-pyrrolidone.

In the ink according to the one example, the nonionic surfactant is preferably an acetylene glycol-based surfactant, and more preferably an ethylene oxide condensate of 2,4,7,9-tetramethyl-5-decyne-4,7-diol. Examples of commercially available products of the acetylene glycol-based surfactant include SURFYNOL (registered trademark) series manufactured by Nissin Chemical co., ltd.

In the ink according to the one example, a total concentration of Ca and Mg in the ink is preferably less than 300 ppm by mass.

—Other Inks—

In the ink jet recording method according to the embodiment of the present disclosure, the ink stored in the container of the ink tank is not limited to the above-described reactive dye-containing ink, and other inks may be used.

As other inks, an ink containing a colorant other than a reactive dye (hereinafter, also simply referred to as a colorant) and water is preferable.

In other inks, the water content is preferably 50 mass % or greater, more preferably 60 mass % or greater, and even more preferably 70 mass % or greater with respect to the total amount of the ink.

Examples of the colorant include organic pigments, inorganic pigments, and dyes.

Examples of the organic pigments include azo pigments, polycyclic pigments, chelate dyes, nitro pigments, nitroso pigments, and aniline black.

Examples of the inorganic pigments include white inorganic pigments, iron oxides, barium yellow, cadmium red, chrome yellow, and carbon black.

The ink containing a colorant and water may optionally contain other components.

As other components, a component contained in a known aqueous ink jet ink can be used.

Examples of other components include components other than a reactive dye in an example of the above-described reactive dye-containing ink.

<Supply Step and Jetting Step>

The supply step is a step of supplying the ink stored in the container in the ink tank to the ink jet head including the silicon-containing nozzle member.

The jetting step is a step of jetting the ink supplied to the ink jet head from the silicon-containing nozzle member in the ink jet head (specifically, from the nozzle provided in the silicon-containing nozzle member).

Both the supply step and the jetting step are preferably performed by the above-described ink jet recording device according to the embodiment of the present disclosure.

Specific conditions of each step are not particularly limited, and known conditions can be appropriately applied.

### EXAMPLES

Hereinafter, the present invention will be described in greater detail using examples, but is not limited to the following examples as long as the gist of the present invention is not impaired. Unless otherwise specified, “%” and “ppm” are based on mass.

### Example 1

<Production of Ink Tank>

An ink tank having the same configuration as the ink tank 10 shown in FIG. 1 was prepared.

As a container for the ink tank, a polyethylene container having a capacity V of 0.002 m³ was prepared. A stirring shaft with a stirrer attached thereto was attached to the container.

Glass beads (UB-1921LN manufactured by Unitika Ltd.; glass particles having an average diameter of 1 mm) as a silicon-containing member were housed in the container. The amount of the glass beads housed was adjusted so that a value of a total surface area of the glass beads was as shown in Table 1. Table 1 also shows the mass % of the glass beads with respect to a total mass of an ink having a volume V (m³). A silicon content of the glass beads was 30 mass %.

The ink tank was obtained as described above.

<Preparation of Reactive Dye Black Ink 1>

A reactive dye black ink 1 (hereinafter, also simply referred to as “black ink 1”) having the following composition was prepared as an ink jet ink.

—Composition of Reactive Dye Black Ink 1—
Reactive Black 39 (reactive dye) . . . 10 mass %
Reactive Brown 11 (reactive dye) . . . 5.7 mass %
Reactive Orange 12 (reactive dye) . . . 3.6 mass %
Urea . . . 10 mass %
Ethylene Glycol . . . 18 mass %
2-Pyrrolidone . . . 5 mass %
SURFYNOL (registered trademark) 465 [acetylene glycol-based surfactant manufactured by Nissin Chemical co., ltd.] . . . 0.6 mass %
N,N-Diethylsulfanilic Acid (DEAS) 1 mass %
Deionized Water . . . the remainder based on a total of 100 mass %

<Ink Injection into Ink Tank and Storage>

The black ink 1 was injected into the container of the ink tank.

In this state, the black ink 1 in the container was stored for 24 hours while being stirred by the stirrer at a liquid temperature of 20° C. to 25° C. (hereinafter, this operation is also simply referred to as “storage”).

<Evaluation of Deterioration of Silicon-Containing Nozzle Member in Ink Jet Head>

The deterioration of the silicon-containing nozzle member in the ink jet head was evaluated by evaluating the deterioration of a nozzle sample imitating the structure of the nozzle plate of the ink jet head.

(Production of Nozzle Sample)

A nozzle sample imitating the structure of the nozzle plate of the ink jet head was produced as follows.

A silicon oxide film (SiO₂ film) having a film thickness of 50 nm was formed on one surface of a monocrystalline silicon substrate of 1 cm×1 cm by a chemical vapor deposition (CVD) method using SiCl₄ and water vapor as a raw material gas.

Next, an oxygen plasma treatment was performed on the surface of the monocrystalline silicon substrate on the SiO₂ film forming side, and then on the SiO₂ film, an ink-repellent film (specifically, a self-assembled monolayer (SAM) film of C₈F₁₇C₂H₄SiCl₃) having a film thickness of 10 nm was formed by the CVD method using C₈F₁₇C₂H₄SiCl₃ and water vapor as a raw material gas.

Thus, a nozzle sample having a lamination structure of ink-repellent film/SiO₂ film/monocrystalline silicon substrate was obtained.

(Evaluation of Deterioration of Silicon-Containing Nozzle Member in Ink Jet Head)

By attaching a polyimide film tape (3M 5413) manufactured by 3M to an exposed surface (that is, a surface on which the ink-repellent film and the SiO₂ film are not formed) of the monocrystalline silicon substrate in the nozzle sample, the exposed surface was coated. Therefore, the elution of silicon from the monocrystalline silicon substrate during the following immersion in the black ink 1 was prevented.

Next, using the black ink 1 prepared as above, an ink contact angle (hereinafter, referred to as “ink contact angle (before immersion)”) of a surface of the ink-repellent film in the nozzle sample with the tape attached thereto was measured. The ink contact angle was measured in the usual manner under an environment of 25° C. and 50 RH % using a contact angle measuring device (DM-500 manufactured by Kyowa Interface Science Co., Ltd.).

The ink contact angle (before immersion) was 85° or greater in all of Example 1 and Examples 2 to 11 and Reference Examples 1 and 2 to be described later.

Next, the nozzle sample after the measurement of the ink contact angle was immersed in the black ink 1 in the container of the ink tank after the storage, and was left at 32° C. for 3 months. After the leaving for 3 months, the nozzle sample was taken out from the ink, and the taken nozzle sample was washed with ultrapure water.

Next, an ink contact angle (hereinafter, referred to as “ink contact angle (after immersion)”) of the surface of the ink-repellent film in the nozzle sample after the washing was measured in the same manner as in the case of the ink contact angle (before immersion). Based on the ink contact angle (after immersion), the deterioration of the silicon-containing nozzle member in the ink jet head was evaluated according to the following evaluation criteria.

The evaluation results are shown in Table 1.

In the following evaluation criteria, a case where the deterioration of the silicon-containing nozzle member in the ink jet head is most suppressed is ranked A.

—Evaluation Criteria for Deterioration of Silicon-Containing Nozzle Member in Ink Jet Head—

A: The ink contact angle (after immersion) was 70° or greater.

B: The ink contact angle (after immersion) was 60° to less than 70°.

C: The ink contact angle (after immersion) was 50° to less than 60°.

D: The ink contact angle (after immersion) was less than 50°.

<Evaluation of Filter Clogging>

The ink tank after the storage, a liquid feed pump, a pressure sensor, a filter, and a pipe were prepared.

Using these members, an ink circulation test device having a circulation path in which the black ink 1 fed from the ink tank passed through the liquid feed pump, the pressure sensor, and the filter in this order and returned to the ink tank was produced.

As the filter, a filter (NY025500 manufactured by Membrane Solusions, LLC.) made of polytetrafluoroethylene (PTFE) and having a diameter of 25 mm and a pore diameter of 5 μm was used.

The liquid feed pump is a pump for feeding and circulating the ink, and the pressure sensor is a sensor for measuring the pressure of the ink during circulation.

In the ink circulation test device, an initial pressure at the start of the circulation was adjusted to be less than 20 kPa, the upper limit of the pressure was set to 50 kPa, and the flow rate of the black ink 1 was adjusted in a range of 10 m/min to 12 m/min.

The liquid feed pump was operated under the above conditions, and the circulation of the black ink 1 was started. The pressure was measured every 10 minutes from the start of the circulation. Based on the pressure at a time point of 60 minutes after the start of the circulation, filter clogging was evaluated according to the following evaluation criteria.

The evaluation results are shown in Table 1.

In the following evaluation criteria, a case where the filter clogging is most suppressed is ranked A.

—Evaluation Criteria for Filter Clogging—

A: The pressure at a time point of 60 minutes after the start of the circulation was less than 20 kPa.

B: The pressure at a time point of 60 minutes after the start of the circulation was 20 kPa to less than 30 kPa.

C: The pressure at a time point of 60 minutes after the start of the circulation was 30 kPa to less than 50 kPa.

D: The pressure reached 50 kPa before a time point of 60 minutes after the start of the circulation.

<Evaluation of Temporal Ink Stability>

The black ink 1 was collected from the ink tank after the storage, and the viscosity of the collected black ink 1 (hereinafter, referred to as “ink viscosity 1”) was measured. The measurement conditions are as follows.

—Conditions for Measuring Ink Viscosity 1—
Viscosity Measuring Device: vibration type viscometer (DV-II+VISCOMETER manufactured by AMETEK Brookfield)
Measurement Environment: atmospheric temperature 32° C., atmospheric relative humidity 50%
Details of Measurement Method: The measurement was performed using a cone plate (φ35 mm) at an ink temperature of 32° C. An average value of data in a torque range of 20% to 90% and in a rotation speed range of 0.5 rpm to 100 rpm was defined as an ink viscosity 1. Here, rpm is an abbreviation for revolutions per minute.

The black ink 1 (100 g) was collected in a glass sample bottle from the ink tank after the storage, and then left for 2 weeks under an environment of 60° C. in a state in which the sample bottle was tightly sealed.

The viscosity of the ink after the leaving for 2 weeks (hereinafter, also referred to as “ink viscosity 2”) was measured under the same measurement conditions as in the case of the ink viscosity 1. Based on the ink viscosity 1 and the ink viscosity 2, an ink viscosity fluctuation rate was calculated by the following expression.

Ink Viscosity Fluctuation Rate (%)=|100−(Ink Viscosity 2/Ink Viscosity 1)×100|

In addition, the presence or absence of precipitates in the ink after the leaving for 2 weeks was visually confirmed.

Based on the ink viscosity fluctuation rate (%) and the visual confirmation results, the temporal ink stability was evaluated according to the following evaluation criteria.

The evaluation results are shown in Table 1.

In the following evaluation criteria, a case where the most excellent temporal ink stability is obtained is ranked A.

—Evaluation Criteria for Temporal Ink Stability—

A: No precipitates were confirmed in the ink, and the ink viscosity fluctuation rate was less than 15%.

B: No precipitates were confirmed in the ink, and the ink viscosity fluctuation rate was 15% to less than 30%.

C: Precipitates were confirmed in the ink.

### Example 2

The same operation as in Example 1 was performed except that the glass beads (UB-1921LN manufactured by Unitika Ltd.; glass particles having an average diameter of 1 mm) were changed to glass beads (UB-2325LN manufactured by Unitika Ltd.; glass particles having an average diameter of 2 mm), and the amount of the glass beads housed in the container was adjusted so that a value of a total surface area of the glass beads was as shown in Table 1.

The results are shown in Table 1.

### Example 3

The same operation as in Example 1 was performed except that the amount of the glass beads housed in the container was adjusted so that a value of a total surface area of the glass beads was as shown in Table 1.

The results are shown in Table 1.

### Example 4

By dividing one silicon wafer having a diameter of 6 inches into nine (specifically, three vertical divisions×three horizontal divisions), nine silicon wafer pieces including one silicon wafer piece of 50 mm square were produced. Three silicon wafers were used to prepare the silicon wafer pieces (that is, 27 pieces).

The same operation as in Example 1 was performed except that the glass beads housed in the container were changed to the 27 silicon wafer pieces.

The results are shown in Table 1.

### Example 5

The same operation as in Example 3 was performed except that the black ink 1 (that is, reactive dye black ink 1) was changed to a pigment black ink A having the following composition.

The results are shown in Table 1.

—Composition of Pigment Black Ink A—
ProJet APD1000 Black (black pigment dispersion) . . . 28.5 mass %
Glycerin . . . 20 mass %
Ethylene Glycol . . . 20 mass %
2-Pyrrolidone . . . 5 mass %
SURFYNOL (registered trademark) 465 [acetylene glycol-based surfactant manufactured by Nissin Chemical co., ltd.] . . . 0.6 mass %
N,N-Diethylsulfanilic Acid (DEAS) 1 mass %
Deionized Water . . . the remainder based on a total of 100 mass %

### Example 6

The same operation as in Example 5 was performed except that the glass beads (UB-1921LN manufactured by Unitika Ltd.; glass particles having a diameter of 1 mm) were changed to glass beads (BZ-01 manufactured by AS ONE Corporation; glass particles having a diameter of 0.1 mm), the amount of the glass beads housed in the container was adjusted so that a value of a total surface area of the glass beads was as shown in Table 1, and the stirring was not performed.

The results are shown in Table 1.

### Example 7

The same operation as in Example 2 was performed except that the amount of the glass beads housed in the container was adjusted so that a value of a total surface area of the glass beads was as shown in Table 1.

The results are shown in Table 1.

### Example 8

The same operation as in Example 1 was performed except that the amount of the glass beads housed in the container was adjusted so that a value of a total surface area of the glass beads was as shown in Table 1.

The results are shown in Table 1.

### Example 9

The same operation as in Example 1 was performed except that the amount of the glass beads housed in the container was adjusted so that a value of a total surface area of the glass beads was as shown in Table 1.

The results are shown in Table 2.

### Example 10

30 pieces of lead glass “LX-57B” (50 mm square, 6 mm thick) manufactured by AS ONE Corporation were prepared.

The same operation as in Example 1 was performed except that the glass beads housed in the container were changed to the 30 pieces of lead glass.

The results are shown in Table 2.

### Example 11

The same operation as in Example 1 was performed except that the capacity V of the container was changed as shown in Table 1, and the glass beads housed in the container were changed to one 6-inch silicon wafer.

The results are shown in Table 2.

The capacity V of the container was changed by cutting the container (that is, polyethylene container) so that a depth of the container was reduced to about ⅓ of the original depth.

### Comparative Example 1

The same operation as in Example 1 was performed except that the glass beads were not used.

The results are shown in Table 2.

### Comparative Example 2

The same operation as in Example 1 was performed except that the amount of the glass beads housed in the container was adjusted so that a value of a total surface area of the glass beads was as shown in Table 1.

The results are shown in Table 2.

### Reference Example 1

The same operation as in Example 1 was performed except that the glass beads were not used, and the black ink 1 (that is, reactive dye black ink 1) was changed to a reactive dye black ink 2 having the following composition.

The results are shown in Table 2.

—Composition of Reactive Dye Black Ink 2—
Reactive Black 39 (reactive dye) . . . 10 mass %
Reactive Brown 11 (reactive dye) . . . 5.7 mass %
Reactive Orange 12 (reactive dye) . . . 3.6 mass %
Urea . . . 10 mass %
Ethylene Glycol . . . 18 mass %
2-Pyrrolidone . . . 5 mass %
SURFYNOL (registered trademark) 465 [acetylene glycol-based surfactant manufactured by Nissin Chemical co., ltd.] . . . 0.6 mass %
N,N-Diethylsulfanilic Acid (DEAS) 1 mass %
Colloidal Silica (solid content) [SNOWTEX (registered trademark) 30 manufactured by Nissan Chemical Corporation, volume average particle diameter 15 nm] . . . 1.3 ppm by mass
Deionized Water . . . the remainder based on a total of 100 mass %

### Reference Example 2

The same operation as in Example 1 was performed except that the glass beads were not used, and the black ink 1 (that is, reactive dye black ink 1) was changed to a reactive dye black ink 3 having the following composition.

The results are shown in Table 2.

—Composition of Reactive Dye Black Ink 3—
Reactive Black 39 (reactive dye) . . . 10 mass %
Reactive Brown 11 (reactive dye) . . . 5.7 mass %
Reactive Orange 12 (reactive dye) . . . 3.6 mass %
Urea . . . 10 mass %
Ethylene Glycol . . . 18 mass %
2-Pyrrolidone . . . 5 mass %
SURFYNOL (registered trademark) 465 [acetylene glycol-based surfactant manufactured by Nissin Chemical co., ltd.] . . . 0.6 mass %
N,N-Diethylsulfanilic Acid (DEAS) 1 mass %
Colloidal Silica (solid content) . . . 13 ppm by mass

[PL-20 manufactured by Fuso Chemical Co., Ltd., volume average particle diameter 241 nm]
Deionized Water . . . the remainder based on a total of 100 mass %

TABLE 1

| | | | Example 1 | Example 2 | Example 3 | Example 4 | Example 5 | Example 6 | Example 7 | Example 8 |
|---|---|---|---|---|---|---|---|---|---|---|
| Ink | Type | | Reactive | Reactive | Reactive | Reactive | Pigment | Pigment | Reactive | Reactive |
| | | | Dye Black | Dye Black | Dye Black | Dye Black | Black | Black | Dye Black | Dye Black |
| | | | Ink 1 | Ink 1 | Ink 1 | Ink 1 | Ink A | Ink A | Ink 1 | Ink 1 |
| | Colloidal Silica | | None | None | None | None | None | None | None | None |
| Ink Tank | Capacity V (m³) of | | 0.002 | 0.002 | 0.002 | 0.002 | 0.002 | 0.002 | 0.002 | 0.002 |
| | Container of Ink Tank | | | | | | | | | |
| | Silicon- | Type | Glass | Glass | Glass | Silicon | Glass | Glass | Glass | Glass |
| | Containing | | Beads | Beads | Beads | Wafer | Beads | Beads | Beads | Beads |
| | Member | | | | | Pieces | | | | |
| | | | | | | (27 pieces) | | | | |
| | | Silicon | 30% | 30% | 30% | 100% | 30% | 30% | 30% | 30% |
| | | Content | | | | | | | | |
| | | (mass %) | | | | | | | | |
| | | Shape of | Spherical | Spherical | Spherical | Square | Spherical | Spherical | Spherical | Spherical |
| | | Silicon- | Shape | Shape | Shape | Plate | Shape | Shape | Shape | Shape |
| | | Containing | | | | Shape | | | | |
| | | Solid Piece | | | | | | | | |
| | | Size of | Diameter | Diameter | Diameter | 50 mm | Diameter | Diameter | Diameter | Diameter |
| | | Silicon- | 1 mm | 2 mm | 1 mm | Square, | 1 mm | 0.1 mm | 2 mm | 1 mm |
| | | Containing | | | | etc. | | | | |
| | | Solid Piece | | | | | | | | |
| | | Mass % with | 1.00 | 2.50 | 2.50 | (omitted) | 2.50 | 0.50 | 25.00 | 30.00 |
| | | respect to | | | | | | | | |
| | | Total Mass of | | | | | | | | |
| | | Ink Having | | | | | | | | |
| | | Volume V (m³) | | | | | | | | |
| | | Total Surface | 0.096 | 0.120 | 0.240 | 0.109 | 0.240 | 0.240 | 1.200 | 2.880 |
| | | Area S (m²) | | | | | | | | |

| | | | | | | | | | |
|---|---|---|---|---|---|---|---|---|---|
| | S/V | 48 | 60 | 120 | 55 | 120 | 120 | 600 | 1440 |
| Evaluation | Deterioration of Silicon- | B | A | A | A | A | A | A | A |
| Results | Containing Nozzle Member | | | | | | | | |
| | in Ink Jet Head | | | | | | | | |
| | Filter Clogging | A | A | A | A | A | B | A | A |
| | Temporal Ink Stability | A | A | A | A | B | B | A | A |

TABLE 2

| | | | | | | Comparative | Comparative | Reference | Reference |
|---|---|---|---|---|---|---|---|---|---|
| | | | Example 9 | Example 10 | Example 11 | Example 1 | Example 2 | Example 1 | Example 2 |
| Ink | Type | | Reactive | Reactive | Reactive | Reactive | Reactive | Reactive | Reactive |
| | | | Dye Black | Dye Black | Dye Black | Dye Black | Dye Black | Dye Black | Dye Black |
| | | | Ink 1 | Ink 1 | Ink 1 | Ink 1 | Ink 1 | Ink 2 | Ink 3 |
| | Colloidal Silica | | None | None | None | None | None | Contained | Contained |
| | | | | | | | | (particle | (particle |
| | | | | | | | | diameter 15 | diameter 241 |
| | | | | | | | | nm, content | nm, content |
| | | | | | | | | 1.3 ppm) | 13 ppm) |
| Ink Tank | Capacity V (m³) of | | 0.002 | 0.002 | 0.0007 | 0.002 | 0.002 | 0.002 | 0.002 |
| | Container of Ink Tank | | | | | | | | |
| | Silicon- | Type | Glass | Lead | Silicon | — | Glass | — | — |
| | Containing | | Beads | Glass | Wafer | | Beads | | |
| | Member | | | (30 pieces) | (one wafer) | | | | |
| | | Silicon | 30% | 15% | 100% | — | 30% | — | — |
| | | Content | | | | | | | |
| | | (mass %) | | | | | | | |
| | | Shape of | Spherical | Square | Circular | — | Spherical | — | — |
| | | Silicon- | Shape | Plate | Plate | | Shape | | |
| | | Containing | | Shape | Shape | | | | |
| | | Solid Piece | | | | | | | |
| | | Size of | Diameter | 50 mm | Diameter | — | Diameter | — | — |
| | | Silicon- | 1 mm | Square | 6 Inches | | 1 mm | | |
| | | Containing | | | | | | | |
| | | Solid Piece | | | | | | | |
| | | Mass % with | 0.01 | (omitted) | (omitted) | — | 0.63 | — | — |
| | | respect to | | | | | | | |
| | | Total Mass of | | | | | | | |
| | | Ink Having | | | | | | | |
| | | Volume V (m³) | | | | | | | |
| | | Total Surface | 0.110 | 0.110 | 0.036 | — | 0.060 | — | — |
| | | Area S (m²) | | | | | | | |

| | | | | | | | | |
|---|---|---|---|---|---|---|---|---|
| | S/V | 55 | 55 | 54 | — | 30 | — | |
| Evaluation | Deterioration of Silicon- | A | B | B | D | D | A | A |
| Results | Containing Nozzle Member | | | | | | | |
| | in Ink Jet Head | | | | | | | |
| | Filter Clogging | A | A | A | A | A | D | D |
| | Temporal Ink Stability | A | A | A | A | A | C | C |

In Tables 1 and 2, “%” and “ppm” mean mass % and ppm by mass, respectively.

As shown in Tables 1 and 2, in Examples 1 to 11 using the ink tank comprising a container for storing an ink jet ink and a silicon-containing member housed in the container, in which an S/V ratio that was a ratio of a total surface area S m² of the silicon-containing member to a capacity V m³ of the container was 40 or greater, the deterioration of the silicon-containing nozzle member in the ink jet head was suppressed.

In addition, in Examples 1 to 11, filter clogging was suppressed, and the temporal ink stability was excellent.

In contrast, in Comparative Example 1 using the ink tank in which no silicon-containing member was housed in a container, it was not possible to suppress the deterioration of the silicon-containing nozzle member in the ink jet head.

It was also not possible to suppress the deterioration of the silicon-containing nozzle member in the ink jet head in Comparative Example 2 using the ink tank in which a silicon-containing member was housed in a container, but the S/V ratio was less than 40.

In Reference Examples 1 and 2, an ink containing a reactive dye and colloidal silica is used, and an ink tank in which no silicon-containing member is housed in a container is used.

In Reference Examples 1 and 2, it was possible to suppress the deterioration of the silicon-containing nozzle member in the ink jet head as in Examples 1 to 11.

However, in Reference Examples 1 and 2, since the ink contained both the reactive dye and the colloidal silica, the filter clogged and the temporal ink stability was poor.

### EXPLANATION OF REFERENCES

10: ink tank
12: container
13: glass particles (silicon-containing particles)
14: glass beads (silicon-containing member)
16: discharge tube
18: stirring shaft
19: stirrer
20: ink
21: ink droplet
30: ink jet head
32: head body
34: nozzle plate
36: ink-repellent film
38: nozzle
40: supply tube
100: ink jet recording device
P1: liquid feed pump
F1: filter

What is claimed is:

1. An ink tank comprising:
a container for storing an ink jet ink; and
a silicon-containing member housed in the container,
wherein an S/V ratio that is a ratio of a total surface area S m² of the silicon-containing member to a capacity V m³ of the container is 40 or greater.

2. The ink tank according to claim 1,
wherein a silicon content of the silicon-containing member is 20 mass % or greater with respect to a total amount of the silicon-containing member.

3. The ink tank according to claim 1,
wherein the S/V ratio is 50 or greater.

4. The ink tank according to claim 1,
wherein the silicon-containing member includes a plurality of silicon-containing solid pieces.

5. The ink tank according to claim 4,
wherein each of the plurality of silicon-containing solid pieces has a size of 50 μm or greater.

6. The ink tank according to claim 4,
wherein as the plurality of silicon-containing solid pieces, at least one selected from the group consisting of silicon-containing substrates and silicon-containing beads is used.

7. The ink tank according to claim 1, further comprising:
a stirring unit for stirring the ink jet ink stored in the container.

8. The ink tank according to claim 1,
wherein the ink jet ink contains a reactive dye.

9. An ink jet recording device comprising:
the ink tank according to claim 1; and
an ink jet head including a nozzle member containing silicon.

10. An ink jet recording method comprising:
preparing the ink tank according to claim 1, in which an ink jet ink is stored in the container;
supplying the ink jet ink stored in the container to an ink jet head including a nozzle member containing silicon; and
jetting the ink jet ink supplied to the ink jet head from the nozzle member of the ink jet head.

11. The ink jet recording method according to claim 10,
wherein the ink jet ink contains a reactive dye.
